(19) United States
(12) Patent Application Publication
(10) Pub. No.: US 2026/0084363 A1
(43) Pub. Date: Mar. 26, 2026

(54) PET AND rPET CONTAINERS FOR LIQUID FOR SEMI-LIQUID PRODUCTS

(71) Applicant: SIDEL PARTICIPATIONS, Octeville-sur-Mer (FR)

(72) Inventors: Mikael DERRIEN, OCTEVILLE- SUR-MER (FR); Michel BOUKOBZA, OCTEVILLE-SUR-MER (FR); Laurent NAVEAU, OCTEVILLE-SUR-MER (FR)

(21) Appl. No.: 19/110,171

(22) PCT Filed: Aug. 22, 2023
(86) PCT No.: PCT/EP2023/072989

§ 371 Date: Mar. 10, 2025

(30) Foreign Application Priority Data
Sep. 9, 2022 (FR) FR2209071

(51) Int. Cl. B29C 49/00; B29C 49/48; B29K 67/00; B29L 31/00

(52) U.S. Cl. CPC B29C 49/071; B29C 2049/4892; B29C 2949/0715; B29C 2949/0771; B29C 2949/0822; B29C 2949/22; B29C 2949/26; B29C 2949/28; B29K 2067/003; B29K 2995/0029; B29K 2995/0097; B29L 2031/716

(57) ABSTRACT

Provided is a container obtained by blow molding or stretch blow molding from a preform made of polyethylene terephthalate and manufacturing methods of containers. The container includes a body, a shoulder extending the upper end of the body, a neck extending from the shoulder, and a bottom which extends at a lower end of the container. The neck can be open and form a rim of the container. The container can be intended to receive a liquid or semi-liquid dairy product such as milk, which can be distributed through a cold chain or at ambient temperature.

### TECHNICAL FIELD

The field of the invention is that of the design and manufacture of containers from preforms made of plastics material. The invention relates more particularly to a design of containers made of plastics material, more specifically made of polyethylene terephthalate (PET), adapted to receive a liquid or semi-liquid product commonly referred to as liquid dairy products (LDP), such as dairy products in particular, or the like, that are distributed in a cold chain or at ambient temperature (aseptic). The invention also relates to a preform and to a mold for manufacturing such containers.

### PRIOR ART

It is well known that a container made of plastics material is obtained by blow-molding or stretch-blow-molding a preform within a mold with the impression of the container.

Before it is blow-molded, with or without stretching, the preform is heated until its constituent material reaches or exceeds its glass transition temperature. For example, if the container is made of polyethylene terephthalate, the glass transition temperature is around 70° C. and may approach 80° C., depending on the formulation of the material.

Plastic containers usually comprise a body extending along a longitudinal axis and having a shape substantially in the form of a cylinder of revolution about the longitudinal axis, a bottom which closes the body at a first end thereof, a shoulder which extends in the continuation of the body from a second end thereof and a bottleneck surmounting the shoulder and having an opening. In addition, according to a conventional design, the bottoms are stiffened by being provided with a hollow shape defining an arch intended to withstand different stresses, said bottom being able to additionally comprise radial stiffeners. These bottoms also define a standing plane for the containers. This means that a container can be set down, stably, on its bottom.

What are furthermore well known in the field of packaging are containers in the form of small bottles with a capacity of less than or equal to 150 ml that are intended to contain liquid dairy products (LDP), such as dairy products in particular that are distributed in a cold chain or at ambient temperature (aseptic) and are liquid or semi-liquid such as drinking yoghurt that may or may not contain probiotics.

These containers are usually obtained either from high-density polyethylene (HDPE) or from polystyrene. Containers obtained from HDPE or polystyrene are described in documents JP2002363297, EP2012999 and U.S. Pat. No. 4,595,552 in particular.

Document JP2002363297 describes a bottle obtained from HDPE that has a low weight, while still retaining the transparency required for food bottles, is rigid, is impact-resistant, has good dimensional stability and does not affect the taste of the contents after long-term storage. This plastic bottle for food has a high-density polyethylene layer having a density greater than 0.950 g·cm⁻³ and a molecular weight distribution of 7.5^{-14.5} defined by Mw (weight-average molecular weight)/Mn (number-average molecular weight) and is formed so as to have at least 80% of the bottle web converted to a thickness of 0.5 mm.

However, this type of HDPE containers has the drawback of being difficult to recycle in a closed cycle, i.e. an HDPE bottle can be recycled into a new HDPE bottle with difficulty, the cost of a bottle made of recycled HDPE, referred to as rHDPE, being particularly high due to recycling difficulties.

Document EP2012999 is also known, which describes a method for manufacturing a plastic container, in particular a plastic bottle, according to which a preform constituted of polystyrene is heated and introduced into a mold cavity of a blow-molding mold of a system for shaping by stretch blow molding. The preform is inflated by a gas injected at an overpressure, usually air, along the cavity of the blow-molding mold and is simultaneously stretched by a stretching rod. The container thus blow-molded is then demolded. The method is characterized by the fact that the polystyrene preform is introduced into the mold cavity, said preform having been manufactured with a mean wall thickness of approximately 1.6 mm to 3.4 mm, and in that the preform is subjected to a stretch-blow-molding process executed at a blowing temperature of 125° C. to 140° C. A preform that is specifically suitable for the method according to the present invention and that is made of special polystyrene is also described.

Furthermore, document U.S. Pat. No. 4,595,552 describes an injection molding device for forming articles made of molded polystyrene, comprising a source for supplying polymer (polystyrene), a mold cavity, a pipe connecting the mold cavity and the supply source, an injection assembly for injecting the molten polymer into the mold cavity and a stop valve that is associated with the pipe and has an elongated central passage terminating in an outlet orifice and a needle that is positioned obliquely with respect to the elongated central passage and is able to be selectively inserted in the orifice in a closed position and is able to be retracted from the orifice and from the elongated central passage so as to provide an unrestricted flow of polymer in an open position.

Such a device makes it possible to lower the temperature of the molten polystyrene during the injection molding without producing undesirable physical effects in the parison being formed. Specifically, since polystyrene has strength characteristics that are lower than those of the majority of plastics used in bottles, the thickness of the wall of a polystyrene bottle generally has to be greater than that of other plastics. Thus, the parison used to produce the blow-molded polystyrene bottle also has to be relatively thick. However, the increased thickness of the polystyrene bottle poses a significant problem from the point of view of production costs. Since the injection-molded parison is thicker than the majority of parisons used in the formation of plastic bottles, the cooling time for the polystyrene parison has to be longer in order to avoid crystallization or similar phenomena that are caused by rapid cooling which has a negative effect on the strength and other characteristics of the completed parison. Since the cooling time for the parison is a critical economical parameter, it is desirable for the polystyrene to be heated to the lowest possible temperature that still enables a correct flow of the polymer into the injection mold. However, if the temperature of the molten polystyrene in the injection mold becomes too low, certain undesirable characteristics, such as weld lines, appear in the parison being formed and/or in the blow-molded bottle that is subsequently formed.

Although said device makes it possible to avoid these drawbacks, polystyrene bottles nevertheless have the drawback of being expensive to recycle. Specifically, the recycling of polystyrene (PS) requires a mechanical treatment and a chemical treatment which make recycling polystyrene expensive. Thus, the manufacture of bottles from recycled polystyrene is too expensive.

There is therefore a need for the manufacture of bottles of small capacity, i.e. a capacity less than or equal to 150 ml, that are obtained from a recyclable and inexpensive material such as polyethylene terephthalate (PET) with the lowest possible weight while having good blowability for high-speed manufacture with perfect control of the material distribution. Specifically, the pursuit of savings on material and of reducing polluting emissions is a dominating factor.

The objective of the invention is in particular to meet this need.

### DISCLOSURE OF THE INVENTION

One of the aims of the invention is therefore to meet this need and to remedy the drawbacks of containers obtained from HDPE or polystyrene by proposing a container, a preform and a mold of simple and inexpensive design, requiring a small quantity of material and having low-pressure blowability which enables high manufacturing rates while maintaining good rigidity.

To this end, and according to the invention, what is proposed is a container obtained by blow molding or stretch blow molding from a preform made of polyethylene terephthalate (PET), comprising a body, a shoulder in the continuation of said body at an upper end thereof, a neck in the continuation of the shoulder, said neck being open and forming a rim of the final container formed from said preform, and a bottom extending at a lower end of the container, said container being intended to receive what is referred to as an aseptic, liquid or semi-liquid product commonly referred to as liquid dairy products (LDP), such as dairy products in particular, or the like, that are distributed in a cold chain or at ambient temperature (aseptic) and having a capacity of less than or equal to 150 ml, noteworthy in that the height of the container from the rim to the bottom of the container is less than or equal to 120 mm, and in that the ratio of the outer diameter of the body to the outer diameter under the neck is between 1.3 and 2.3, the height of the neck being less than 15 mm.

Such features provide good blowability, including at low blowing pressure, and a container that is sufficiently rigid while having a particularly low weight, of the order of 5 grams for a container of 150 ml. Thus, in addition to the fact that PET is recyclable in a closed circuit, the container according to the invention allows containers to be manufactured at a very low cost due to its good low-pressure blowability, which enables high manufacturing rates, and a small quantity of material (PET) for its manufacture.

Preferably, the ratio of the area of the container under the neck, expressed in cm², to the weight of said container, expressed in grams, is between 18 and 45.

Furthermore, the outer diameter under the neck is preferably less than or equal to 31 mm and the maximum outer diameter of the body is less than or equal to 54 mm.

Advantageously, the body has, over all or part of its height, a superposition of annular stiffeners, said stiffeners improving the rigidity of said container.

In addition, the bottom comprises a peripheral seat and a concave central dome, in the form of a substantially spherical cap with its concavity facing toward the outside of the container, said central dome being rigid or semi-rigid.

Additionally, said central dome may comprise one or more stiffeners in order to increase the rigidity of the bottom.

In this respect, said central dome may comprise a plurality of radial stiffeners extending substantially from the center of said central dome to the peripheral seat.

Additionally, the body comprises, between the central part of the body and the neck, an annular groove forming a constriction that improves the gripping of the container in particular.

Another object of the invention relates to a preform intended for the forming of containers by blow molding or stretch blow molding according to the invention, said preform being made of polyethylene terephthalate (PET) and comprising a neck, a body and a bottom, said body exhibiting symmetry of revolution about a central axis C, having a portion that is a cylinder of revolution and being formed by a wall which has an outer skin and an inner skin, the bottom being situated at one of the ends of the body, closing the latter, and the neck extending in the continuation of the body at the opposite end of the body, said neck being open and forming a rim of the final container formed from said preform; said preform is noteworthy in that it has a height from the rim to the bottom of less than or equal to 50 mm, an outer diameter of the body of less than or equal to 25 mm and a thickness of the wall of the body, that is to say the thickness between the inner skin and the outer skin, of between 1.2 and 2.0 mm.

Preferably, the bottom of the preform has a substantially hemispherical shape and an outer radius of curvature of between 6 and 13 mm.

Additionally, said preform comprises at least one additive providing the polyethylene terephthalate with the property to at least partially filter the visible spectrum of light.

A last object of the invention relates to a mold for manufacturing a container by blow-molding or stretch-blow-molding a preform made of polyethylene terephthalate (PET) according to the invention, said mold comprising at least a mold bottom capable of being movably mounted in a lateral wall which defines a cavity with the impression of part of the container, said lateral wall comprising two half-molds that each define a half-impression of the body of the container and are mounted rotatably with respect to one another, between what is referred to as an open position, in which the half-molds are spaced apart angularly from one another and the mold bottom is lowered relative to the half-molds so as to enable the introduction of the blank and the discharge of the formed container, and what is referred to as a closed position, in which the half-molds are applied against one another and enclose between them the mold bottom so as to thus form the cavity and define the full impression of the container to be formed; said mold being noteworthy in that the half-impressions of the lateral walls and/or the mold bottom are shaped so as to produce a container according to the invention.

### BRIEF DESCRIPTION OF THE DRAWINGS

Further advantages and features will become better apparent from the following description of several embodiment variants, given by way of nonlimiting examples, of the container, of the preform and of the mold for producing said container according to the invention, with reference to the attached drawings, in which:

FIG. 1 is a perspective view of the container according to the invention;

FIG. 2 is a side view of the container according to the invention shown in FIG. 1;

FIG. 3 is a bottom view of the container according to the invention, that is to say a view showing the bottom of the container;

FIG. 4 is a side view of a preform according to the invention for manufacturing a container according to the invention;

FIG. 5 is a view in elevation of the preform shown in FIG. 4;

FIG. 6 is a partial perspective view in transparency of a mould for manufacturing a container according to the invention from a preform according to the invention.

### EMBODIMENT OF THE INVENTION

In the remainder of the description of the container according to the invention, the same numerical references denote the same elements. The different views are not necessarily drawn to scale.

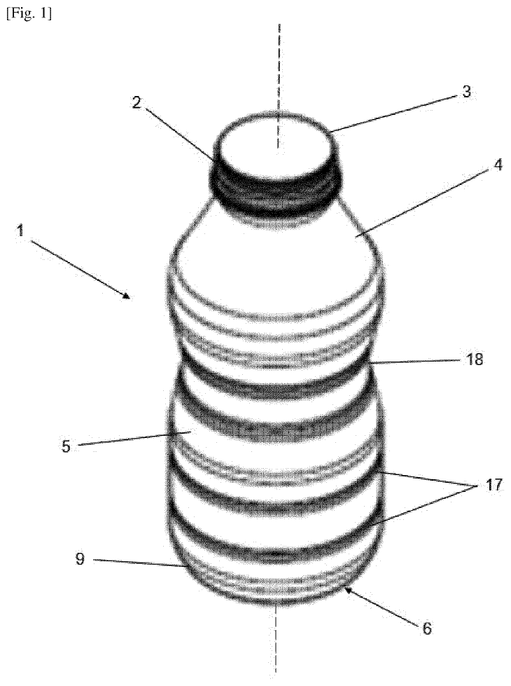

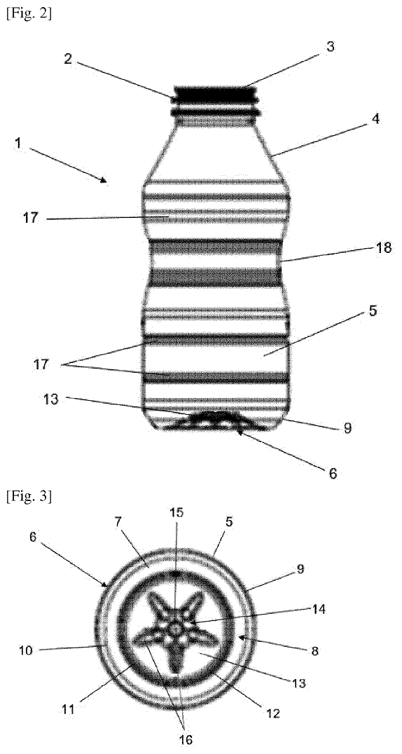

FIGS. 1 to 3 show a container 1, in the present case a bottle, produced by stretch blow molding from a preform made of thermoplastic material such as polyethylene terephthalate (PET), which will be described in detail later.

Said container 1 comprises, at an upper end, a threaded neck 2 provided with a rim 3. In the continuation of the neck 2, the container 1 comprises, in its upper part, a shoulder 4 that widens in the direction away from the neck 2, this shoulder 4 being extended by a lateral wall or body 5, in the general shape of a cylinder of revolution about a main axis X of the container 1.

It goes without saying that the body 5 could have a different shape such as a square cross section with edges of quarter-round shape, for example, without thereby departing from the scope of the invention.

The container 1 further comprises a bottom 6 which extends at a lower end of the container 1. Said bottom 6, with reference to FIG. 3, comprises a seat 7 in the form of a thin annular bead which extends substantially axially in the continuation of the body 5. The seat 7 terminates in a continuous planar and annular face which forms the lower end of the container 1 and defines a standing plane 8 perpendicular to the axis of the container 1, by means of which the latter can rest stably on a planar surface. The standing plane 8 is connected outwardly to an outer lateral face 9 of the seat 7 (which extends in the continuation of the body 5) by a fillet 10 with a small radius of curvature, that is to say of the order of one millimeter.

Toward the inside of the container 1, the seat 7 comprises an annular flange 11, which extends axially toward the inside of the container 1 in the continuation of the standing plane 8. The standing plane 8 is connected inwardly to the flange 11 by a fillet 12 which is preferably of small radius of curvature. The bottom 6 further comprises a concave central dome 13, in the form of a substantially spherical cap with its concavity facing toward the outside of the container and which extends in the continuation of the flange 11 (which forms a junction between the standing plane 8 and the arch 13) up to a central zone 14 forming a pin 15 which projects axially toward the inside of the container 1, said central dome 13 being rigid or semi-rigid. As illustrated in the drawings, the bottom 6 is furthermore provided with a series of stiffeners 16 which extend from the central zone 14 substantially up to the standing plane 8. Preferably, the stiffeners 16 do not extend beyond the standing plane 8, that is to say they do not overhang on the outer lateral face 9. In this particular exemplary embodiment, there are five of said stiffeners 16; however, this number is provided by way of example and could be different.

Furthermore, it goes without saying that said stiffeners may extend beyond the standing plane 8 by overhanging on the outer lateral face 9 without thereby departing from the scope of the invention. In addition, the body 5 has, over all or part of its height, a superposition of annular stiffeners 17 making it possible to increase the rigidity of said body 5.

Additionally, the body 5 comprises, between the central part of the body 5 and the neck 2, an annular groove 18 forming a constriction that notably provides better gripping of the container and improves the rigidity of the body 5 of the container 1.

According to an essential feature of the container 1 according to the invention, the height of said container 1 from the rim 3 to the bottom 6 of the container 1 is less than or equal to 120 mm and the ratio defined as being the ratio of the outer diameter of the body 5 to the outer diameter under the neck 2 is between 1.3 and 2.3, the height of the neck being less than 15 mm. These features provide good blowability, including at low blowing pressure, and, ultimately, a container that is sufficiently rigid while having a particularly low weight, less than or equal to 5 grams depending on the capacity of the container which is less than or equal to 150 ml. Low blowing pressure is understood to mean a blowing pressure of between 10 and 18 bar. Thus, in addition to the fact that PET is recyclable in a closed circuit, the container according to the invention allows containers to be manufactured at a very low cost due to the good match between the preform, the packaging, which enables optimal weight reduction whether virgin PET or recycled PET (referred to as rPET) at extremely reduced blowing pressures, and a maximum production rate.

Furthermore, the ratio of the area of the container under the neck, expressed in cm², to the weight of said container, expressed in grams, is between 18 and 45, the outer diameter under the neck is preferably less than or equal to 31 mm and the maximum outer diameter of the body is less than or equal to 54 mm.

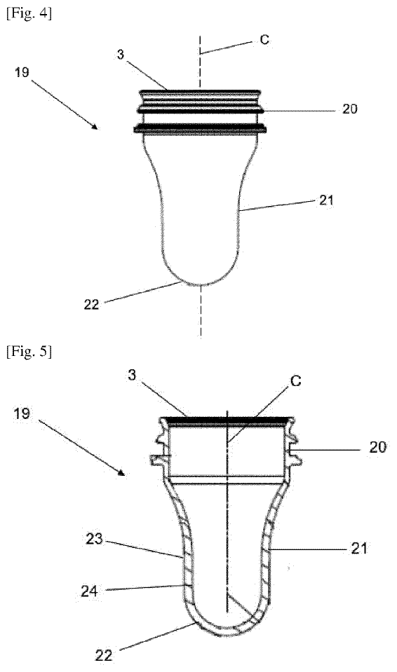

In order to manufacture containers according to the invention, with reference to FIGS. 4 and 5, the preform 19 intended for the forming of containers by blow molding or stretch blow molding according to the invention is obtained from polyethylene terephthalate (PET) and usually comprises a neck 20, a body 21 and a bottom 22, said body 21 exhibiting symmetry of revolution about a central axis C, having a portion that is a cylinder of revolution and being formed by a wall which has an outer skin 23 and an inner skin 24, the bottom 22 being situated at one of the ends of the body 21, closing the latter, and the neck 20 extending in the continuation of the body 21 at the opposite end to the bottom 22, said neck 20 being open and forming a rim 3 of the final container 1 formed from said preform 19.

Said preform has a height from the rim 3 to the bottom 22 of less than or equal to 50 mm, an outer diameter of the body 21 of less than or equal to 25 mm and a thickness of the wall of the body 21, that is to say the thickness between the inner skin 24 and the outer skin 23, of between 1.2 and 2.0 mm.

Preferably, the bottom of the preform has a substantially hemispherical shape and an outer radius of curvature of between 6 and 13 mm.

Additionally, said preform comprises at least one additive providing the polyethylene terephthalate with the property to at least partially filter the visible spectrum of light.

According to a well-known example, for dairy products, said preform 19 made of PET resin is supplemented with titanium dioxide (TiO2). Titanium dioxide provides the white color and, in certain proportions well known to those skilled in the art, the functionality of a barrier to light in the visible part of the spectrum and prevents the degradation of riboflavin (vitamin B2).

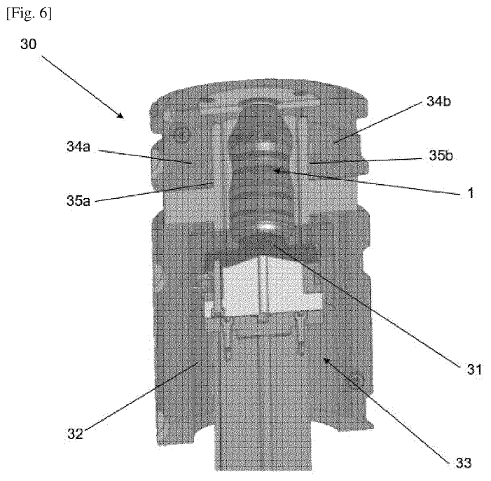

Furthermore, with reference to FIG. 6, for the manufacture of a container by blow-molding or stretch-blow-molding a preform 19 made of polyethylene terephthalate (PET) as described above, use is made of a mold 30 comprising at least a mold bottom 31 capable of being movably mounted in a lateral wall 32 which defines a cavity 33 with the impression of part of the container 1, said lateral wall 32 comprising two half-molds 34a, 34b that each define a half-impression 35a, 35b of the body 5 of the container 1 and are mounted rotatably with respect to one another, between what is referred to as an open position, in which the half-molds 34a, 34b are spaced apart angularly from one another and the mold bottom 31 is lowered relative to the half-molds 34a, 34b so as to enable the introduction of the preform 19 and the discharge of the formed container 1, and what is referred to as a closed position, in which the half-molds 34a, 34b are applied against one another and enclose between them the mold bottom 31 so as to thus form the cavity 33 and define the full impression of the container 1 to be formed. The half-impressions 35a, 35b of the lateral walls 32 and/or the mold bottom 31 are shaped so as to produce a container 1 according to the invention.

Finally, it is quite clear that the examples which have just been given are only particular illustrations in no way limiting the fields of application of the invention.

1. A container obtained by blow molding or stretch blow molding from a preform made of polyethylene terephthalate (PET), the container comprising:
a body;
a shoulder in a continuation of said body at an upper end thereof;
a neck in the continuation of the shoulder, said neck being open and forming a rim of the final container formed from said preform; and
a bottom extending at a lower end of the container, said container being configured to receive a liquid or semi-liquid product distributed in a cold chain or at ambient temperature, the container having a capacity of less than or equal to 150 ml, wherein a height of the container from the rim to a bottom of the container is less than or equal to 120 mm, and wherein a ratio of an outer diameter of the body an outer diameter under the neck is between 1.3 and 2.3, and wherein a height of the neck is less than 15 mm.

2. The container as claimed in claim 1, wherein a ratio of an area of the container under the neck, expressed in cm², to a weight of said container, expressed in grams, is between 18 and 45.

3. The container as claimed in claim 1, wherein the outer diameter under the neck is less than or equal to 31 mm.

4. The container as claimed in claim 1, wherein a maximum outer diameter of the body is less than or equal to 54 mm.

5. The container as claimed in claim 1, wherein the body has a superposition of annular stiffeners over all or part of a body height.

6. The container as claimed in claim 1, wherein the bottom comprises a peripheral seat and a central concave dome, wherein the dome has a form of a substantially spherical cap comprising a concavity facing toward an outside of the container.

7. The container as claimed in claim 6, wherein said central concave dome is rigid or semi-rigid.

8. The container as claimed in claim 7, wherein said central concave dome comprises one or more stiffeners.

9. The container as claimed in claim 7, wherein said central dome comprises a plurality of radial stiffeners extending substantially from the center of said central dome to the peripheral seat.

10. The container as claimed in any claim 1, wherein the body comprises an annular groove forming a constriction between the central part of the body and the neck

11. A preform for the forming a container by blow molding or stretch blow molding, said preform being made of polyethylene terephthalate (PET) and comprising:
a neck;
a body; and
a bottom;
said body exhibiting symmetry of revolution about a central axis C, the body further comprising a portion that is a cylinder of revolution and being formed by a wall which has an outer skin and an inner skin,
the bottom being situated at one end of the body and closing the body,
the neck extending in a continuation of the body at an opposite end of the body, said neck being open and forming a rim of a final container formed from said preform, wherein said preform has a height from the rim to the bottom of less than or equal to 50 mm, an outer diameter of the body of less than or equal to 25 mm and a thickness of the wall of the body between the inner skin and the outer skin of between 1.2 and 2.0 mm.

12. The preform as claimed in claim 11, wherein the bottom has a substantially hemispherical shape.

13. The preform as claimed in claim 12, wherein the bottom has an outer radius of curvature of between 6 and 13 mm.

14. The preform as claimed in claim 11, further comprising at least one additive providing the polyethylene terephthalate with a property to at least partially filter a visible spectrum of light.

15. A mold for manufacturing a container by blow-molding or stretch-blow-molding a preform made of polyethylene terephthalate (PET), said mold comprising:
at least a mold bottom configured to be movably mounted in a lateral wall, wherein the wall defines a cavity comprising an impression of part of the container, said lateral wall comprising two half-molds that each define a half-impression of the body of the container and are mounted rotatably with respect to one another between an open position and a closed position,
wherein in the open position, in which the two half-molds are spaced apart angularly from one another and the mold bottom is lowered relative to the half-molds so as to enable the introduction of a blank and a discharge of a formed container, and
wherein in the closed position, the two half-molds are applied against one another with the mold bottom enclosed therebetween so as to form the cavity and define a full impression of the container to be formed, wherein the half-impressions of the lateral walls and/or the mold bottom are shaped so as to produce a container comprising:
a body;
a shoulder in a continuation of said body at an upper end thereof;
a neck in the continuation of the shoulder, said neck being open and forming a rim of the final container formed from said preform; and
a bottom extending at a lower end of the container, said container being configured to receive a liquid or semi-liquid product distributed in a cold chain or at ambient temperature, the container having a capacity of less than or equal to 150 ml, wherein a height of the container from the rim to a bottom of the container is less than or equal to 120 mm, and wherein a ratio of an outer diameter of the body an outer diameter under the neck is between 1.3 and 2.3, and wherein a height of the neck is less than 15 mm.

16. The container of claim 1, wherein the liquid or semi-liquid product is a dairy product.
